(19) United States
(12) Patent Application Publication
(10) Pub. No.: US 2020/0378579 A1
(43) Pub. Date: Dec. 3, 2020

(54) LED LAMP AND LED EMISSION SYSTEM THEREOF

(71) Applicant: XIAMEN ECO LIGHTING CO. LTD., Xiamen (CN)

(72) Inventors: Jianxin XIE, Xiamen (CN); Xinghan LAI, Xiamen (CN)

(21) Appl. No.: 16/820,706

(22) Filed: Mar. 17, 2020

(30) Foreign Application Priority Data
May 27, 2019 (CN) 201910445443.4

(51) Int. Cl. F21V 9/38; F21V 9/32; F21V 23/04

(52) U.S. Cl. CPC F21V 9/38; F21Y 2115/10; F21V 23/0435; F21V 9/32

(57) ABSTRACT

A LED emission system includes an illuminating element set and a control module. The illuminating element set includes a first illuminating element and a second illuminating element. The first illuminating element illuminates a first spectrum. And the second illuminating element illuminates a second spectrum. The control module includes a control unit and an illuminating element switch. The control unit generates a switch command. The illuminating element switch receives the switch command and switch on or off the first illuminating element and/or the second illuminating element according to the switch command. The switch command sets a first current amplitude for activating the first illuminating element. Also, the switch command sets a second current amplitude for activating the second illuminating element. Such that the second spectrum compensates the first spectrum.

### FIELD OF THE INVENTION

The present invention relates to a LED emission system and a LED lamp that includes the LED emission system, more particularly, to a LED emission system capable of compensating its spectrums and a LED lamp that includes such LED emission system.

### BACKGROUND OF THE INVENTION

A conventional LED lamp is efficient in its electricity-to-photo transition and also has a sufficient long life cycle. Therefore, such convention LED lamp acts an important role in efficient energy consumption. Such conventional LED lamp has a blue LED light source that is coated with a combination of yellow and green fluorescent powders or another combination of yellow, green and red fluorescent powders. Such that the conventional LED lamp simulates a white light (or daylight) by combining colors of and/or reflected from the above combinations.

However, the resulting white light may not be continuous in its spectrum. More specifically, the combined white light's spectrum may substantially introduce a peak at a short-wavelength blue color or a trough at a long-wavelength red color. As a result, the conventional LED lamp may emit a discontinuous light wave at wavelengths of certain colors. That is, forming diffused edges that can be observed clearly.

### SUMMARY OF THE INVENTION

The present invention aims at disclosing a LED emission system that compensates the abovementioned peak and/or trough in the combined white light's wavelength for substantially neutralizing the white light's discontinuity in its wavelength. And as a result, the white light's observable discontinuity in the form of diffused edges is substantially smoothed as well.

According to one embodiment, the present invention discloses a LED emission system that includes an illuminating element set and a control module. The illuminating element set includes a first illuminating element and a second illuminating element. The first illuminating element illuminates a first spectrum. And the second illuminating element illuminates a second spectrum. The control module includes a control unit and an illuminating element switch. The control unit generates a switch command. The illuminating element switch receives the switch command and switch on or off the first illuminating element and/or the second illuminating element according to the switch command. The switch command sets a first current amplitude for activating the first illuminating element. Also, the switch command sets a second current amplitude for activating the second illuminating element. Such that the second spectrum compensates the first spectrum. In one example, the first illuminating element is coated with a first type of fluorescent powder. And the second illuminating element is coated with a second type of fluorescent power. In addition, the first type of fluorescent powder has a different color from the second type of fluorescent powder.

In one example, the first spectrum is adjusted according to a ratio of the first type of fluorescent powder.

In one example, the second spectrum is adjusted according to a ratio of the second type of fluorescent powder.

In one example, the first illuminating element additionally emits a blue light. And the second illuminating element also emits a purple light.

In one example, the first illuminating element is coated with a first type of fluorescent powder. And the second illuminating element is coated with a second type of fluorescent power. Moreover, the first type of fluorescent powder has a different color from the second type of fluorescent powder. Specifically, a color of the first type of fluorescent powder is selected from a group consisting of blue, green, yellow and red. Similarly, a color of the second type of fluorescent powder is selected from a group consisting of blue, green, yellow and red.

In one example, the first illuminating element emits a purple light and coated with a blue fluorescent powder. And the second illuminating element emits a blue light.

In one example, the first illuminating element emits a blue light. Also, the second illuminating element emits a purple light. Moreover, one of the first illuminating element and the second illuminating element is coated with a blue fluorescent powder.

In one example, the illuminating element set additionally includes a first input circuit and a second input circuit. The first input circuit switches on or off the first illuminating element in response to an operation of the illuminating element switch. Similarly, the second input circuit switches on or off the second illuminating element in response to the operation of the illuminating element switch.

In one example, the first illuminating element applies a white light that has an adjustable color temperature. Also, in one example, the adjustable color temperature is substantially equal to 4000 Kelvin (K), 5000K or 2700K.

In one example, the illuminating element set additionally includes a third illuminating element and a fourth illuminating element. The third illuminating element illuminates a third spectrum. Also, the fourth illuminating element illuminates a fourth spectrum.

In one example, the first illuminating element also emits a white light. And the second illuminating element additionally emits a red light. Moreover, the third illuminating element emits a green light. Last, the fourth illuminating element emits a blue light.

In one example, the control unit also stores voltage data for commanding a corresponding illuminating element to emit a target color temperature.

In one example, at least one of the first illuminating element and the second illuminating element includes a chip-on-board (COB) light source. In addition, the COB light source is single-surfaced or multiple-surfaced.

In one example, at least one of the first illuminating element and the second illuminating element includes a surface-mount device (SMD).

In one example, the illuminating element set includes a reflector that reflects lights emitted from the surface-mount device for focusing the lights.

In one example, the LED emission system also includes a radio communication module that receives a manual command for generating the switch command.

The present invention also discloses a LED lamp that includes an LED emission system and a lampshade. The LED emission system includes an illuminating element set and a control module. The illuminating element set includes a first illuminating element and a second illuminating element. The first illuminating element illuminates a first spectrum. And the second illuminating element illuminates a second spectrum. The control module includes a control unit and an illuminating element switch. The control unit generates a switch command. The illuminating element switch receives the switch command and switches on or off the first illuminating element and/or the second illuminating element according to the switch command. The switch command sets a first current amplitude for activating the first illuminating element. Also, the switch command sets a second current amplitude for activating the second illuminating element. Such that the second spectrum compensates the first spectrum. The lampshade covers the illuminating element set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a LED emission system according to one embodiment of the present invention.

### DETAILED DESCRIPTION

As mentioned above, the present disclosure discloses a LED emission system that can neutralize the conventional LED lamp's discontinuity in its emission wavelength.

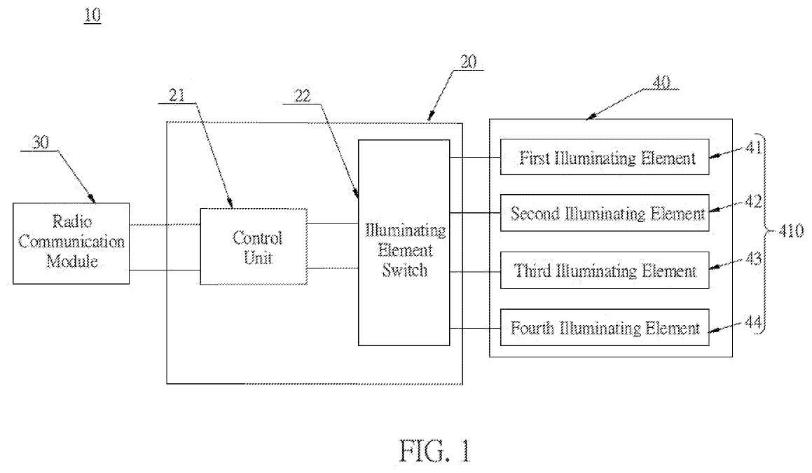

According to one embodiment, FIG. 1 illustrates a block diagram of a LED emission system 10 that includes an illuminating element set 40 and a control module 20.

The illuminating element set 40 includes multiple illuminating elements, for example, a first illuminating element 41 and a second illuminating element 42. In some examples, the illuminating elements are implemented using LEDs. More specifically, the first illuminating element 41 has a first spectrum, such as a white spectrum. And the second illuminating element 42 has a second spectrum that substantially compensates the first spectrum, such as a white-compensating spectrum.

The control module 20 is electrically coupled to the illuminating element set 40. Also, the control module 20 controls which illuminating element(s) to be activated and a corresponding current amplitude for driving the activated illuminating element(s).

Specifically, the control module 20 has a control unit 21 and an illuminating element switch 22. The control unit 21 generates a switch command. In addition, the switch command records which illuminating element(s) within the illuminating element set 40 to be activated. Also, the switch command records appropriate current amplitudes for driving the activated illuminating element(s).

Then, the illuminating element switch 22 receives the switch command from the control unit 21. In addition, the illuminating element switch 22 switches on or off illuminating element(s) according to the switch command's instruction. Specifically, with the aid of the switch command, the control unit 21 controls both the first illuminating element 41 and the second illuminating element 42's current amplitudes. Such that the second illuminating element 42 emits the second spectrum in a way that compensates the first spectrum's defective peaks and troughs emitted by the first illuminating element 41. In this way, the illuminating element set 40 emits a smooth and substantially defect-free spectrum, i.e., the illuminating element set 40's target spectrum. In addition, the illuminating element set 40's can better simulate daylight that keep human eyes from being damaged by repeated light peaks and troughs.

In some examples, the illuminating element set 40's target spectrum may be a daylight spectrum of different color temperatures. The illuminating element set 40 is capable of adjusting its color temperature via the switch command that applies appropriate current amplitudes on the illuminating element set 40's different illuminating elements. In some examples, the illuminating element set 40's target spectrum may be 2700 Kelvin(K), 4000K, or 5000K.

In some examples, both the first illuminating element 41 and the second illuminating element 42 are implemented using LED chips that emit lights of same or different colors. Optionally, both the first illuminating element 41 and the second illuminating element 42 are further coated with fluorescent powders of different reflective colors. In this way, the LED emission system 10 gains more flexibility in adjusting its spectrum compensation and color temperature. In some examples, the first illuminating element 41 is a LED chip that emits a blue color, and the second illuminating element 42 is a LED chip that emits a purple color. Optionally, at least one of the first illuminating element 41 and the second illuminating element 42 is coated with a fluorescent powder that reflects a color of blue, green, yellow or red.

In some examples, a ratio or type of used fluorescent powder that is coated on a LED chip can be adjusted for adjusting the LED chip's target spectrum and/or color temperature. In this way, the illuminating element set 40's target spectrum and/or color temperature can be better adjusted by precisely disposing fluorescent powders that are applied on each the illuminating element.

In some examples, the illuminating element 41 is a LED chip that emits a purple light. Also, the illuminating element 41 is coated with a fluorescent powder that reflects a blue light. In addition, the second illuminating element 42 is a LED chip that emits a blue light. Therefore, the first illuminating element 41's purple light and blue reflective light are mixed to form a visible shortwave spectrum. And the second illuminating element 42's blue light compensates the visible shortwave spectrum to keep the visible shortwave spectrum's continuity. Such that a resulting spectrum has a good similarity to daylight.

In some examples, the first illuminating element 41 is a LED chip that emits a blue light, and the second illuminating element 42 is a LED chip that emits a purple light. Additionally, both the first illuminating element 41 and the second illuminating element 42 are coated with a fluorescent powder that reflects a red light. Therefore, the first illuminating element 41's blue light and/or the second illuminating element 42's purple light are mixed with the fluorescent powder's red light. Such that the fluorescent powder's red light compensates the first illuminating element's blue light and/or the second illuminating element's purple light in a longwave visible light's spectrum. Such that a resulting spectrum has a good similarity to daylight. In some examples, the illuminating element set 40 has more than two illuminating elements, for example, four illuminating elements. The actual number of applied illuminating elements can be further increased according to various requirements. Optionally, the illuminating element set 40 further includes a third illuminating element 43 and a fourth illuminating element 44.

In some examples, the first illuminating element 41 emits a white light of 4000K, the second illuminating element 42 emits a white light of 5000K, the third illuminating element 43 emits a white light of 2700K, and the fourth illuminating element 44 emits a compensating light that compensates the first illuminating element 41, the second illuminating element 42 and the third illuminating element 43's spectrums' peaks and/or troughs. Specifically, when the first illuminating element 41 illuminates alone, its emission simulates a morning's sunshine by its color temperature of 4000K. Also, when the second illuminating element 42 illuminates alone, its emission simulates a noon's sunshine by its color temperature of 5000K. And when the third illuminating element 43 illuminates alone, its emission simulates a twilight's sunshine by its color temperature of 2700K. The fourth illuminating element 44's emission can compensate the above three types of emission via the switch command's appropriate setting. In some examples, the first illuminating element 41 emits a white light, the second illuminating element 42 emits a red light, the third illuminating element 43 emits a green light, and the fourth illuminating element 44 emits a blue light. Specifically, the control unit 21 stores voltage/current standard data for generating lights of various spectrums and/or color temperatures. Such that the control unit 21 is capable of generating the switch command to adjust the four illuminating elements for a desired spectrum and/or color temperature. For example, the second illuminating element 42's red light may compensate the first illuminating element 41's white light's longwave spectrum. In addition, the third illuminating element 43's green light may compensate the first illuminating element 41's white light's shortwave spectrum. Similarly, the fourth illuminating element 44's blue light may compensate the first illuminating element 41's white light's ultra-shortwave spectrum. Such that the first illuminating element 41's white light shows continuity and prevents itself from damaging human eyes.

In some examples, at least one of the illuminating elements in the illuminating element set 40 is implemented using a chip-on-board (COB) light source. Optionally, the COB light source is single-surfaced or multiple-surfaced.

In some examples, at least one of the illuminating elements in the illuminating element set 40 includes a surface-mount device (SMD). Optionally, the illuminating element set 40 additionally includes a reflector that reflect lights emitted from the surface-mount device for focusing emitted lights.

In some examples, as shown in FIG. 1, the LED emission system 10 further includes a radio communication module 30. And the radio communication module 30 receives required information and relays it to the control unit 21. Such that the control unit 21 can generate the switch command based on the relayed information. The present disclosure additionally provides a LED lamp that dispose a lampshade to cover the LED emission system 10 for LED lamp fabrication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A LED emission system, comprising:
an illuminating element set, comprising:
a first illuminating element, configured to illuminate a first spectrum; and
a second illuminating element, configured to illuminate a second spectrum; and
a control module, comprising:
a control unit, configured to generate a switch command; and
an illuminating element switch, configured to receive the switch command and switch on or off the first illuminating element and/or the second illuminating element according to the switch command;
wherein the switch command is configured to set a first current amplitude for activating the first illuminating element and set a second current amplitude for activating the second illuminating element, such that the second spectrum compensates the first spectrum.

2. The LED emission system of claim 1, wherein the first illuminating element is coated with a first type of fluorescent powder, the second illuminating element is coated with a second type of fluorescent power, and the first type of fluorescent powder has a different color from the second type of fluorescent powder.

3. The LED emission system of claim 2, wherein the first spectrum is adjusted according to a ratio of the first type of fluorescent powder.

4. The LED emission system of claim 2, wherein the second spectrum is adjusted according to a ratio of the second type of fluorescent powder.

5. The LED emission system of claim 1, wherein the first illuminating element is further configured to emit a blue light, and the second illuminating element is further configured to emit a purple light.

6. The LED emission system of claim 5, wherein the first illuminating element is coated with a first type of fluorescent powder, the second illuminating element is coated with a second type of fluorescent power;
wherein the first type of fluorescent powder has a different color from the second type of fluorescent powder; and
wherein a color of the first type of fluorescent powder is selected from a group consisting of blue, green, yellow and red, and a color of the second type of fluorescent powder is selected from a group consisting of blue, green, yellow and red.

7. The LED emission system of claim 1, wherein the first illuminating element is further configured to emit a purple light and coated with a blue fluorescent powder, and the second illuminating element is further configured to emit a blue light.

8. The LED emission system of claim 1, wherein the first illuminating element is further configured to emit a blue light, and the second illuminating element is further configured to emit a purple light; and
wherein one of the first illuminating element and the second illuminating element is coated with a blue fluorescent powder.

9. The LED emission system of claim 1, wherein the illuminating element set further comprises:
a first input circuit, configured to switch on or off the first illuminating element in response to an operation of the illuminating element switch; and
a second input circuit configured to switch on or off the second illuminating element in response to the operation of the illuminating element switch.

10. The LED emission system of claim 9, wherein the first illuminating element is further configured to apply a white light that has an adjustable color temperature.

11. The LED emission system of claim 10, wherein the adjustable color temperature is substantially equal to 4000 Kelvin (K), 5000K or 2700 K.

12. The LED emission system of claim 1, wherein the illuminating element set further comprises:
a third illuminating element, configured to illuminate a third spectrum; and
a fourth illuminating element configured to illuminate a fourth spectrum.

13. The LED emission system of claim 12, wherein the first illuminating element is further configured to emit a white light, the second illuminating element is further configured to emit a red light, the third illuminating element is further configured to emit a green light, and the fourth illuminating element is further configured to emit a blue light.

14. The LED emission system of claim 1, wherein the control unit is further configured to store voltage data for commanding a corresponding illuminating element to emit a target color temperature.

15. The LED emission system of claim 1, wherein at least one of the first illuminating element and the second illuminating element comprises a chip-on-board (COB) light source.

16. The LED emission system of claim 15, wherein the COB light source is single-surfaced or multiple-surfaced.

17. The LED emission system of claim 1, wherein at least one of the first illuminating element and the second illuminating element comprises a surface-mount device (SMD).

18. The LED emission system of claim 17, wherein the illuminating element set further comprises a reflector, configured to reflect lights emitted from the surface-mount device for focusing the lights.

19. The LED emission system of claim 1, further comprising:
a radio communication module configured to receive a manual command for generating the switch command.

20. A LED lamp, comprising:
an LED emission system, comprising:
an illuminating element set, comprising:
a first illuminating element, configured to illuminate a first spectrum; and
a second illuminating element, configured to illuminate a second spectrum; and
a control module, comprising:
a control unit, configured to generate a switch command; and
an illuminating element switch, configured to receive the switch command and switch on or off the first illuminating element and/or the second illuminating element according to the switch command;
wherein the switch command is configured to set a first current amplitude for activating the first illuminating element and set a second current amplitude for activating the second illuminating element, such that the second spectrum compensates the first spectrum; and
a lampshade configured to cover the illuminating element set.
